(19) United States
(12) Patent Application Publication
(10) Pub. No.: US 2021/0147654 A1
(43) Pub. Date: May 20, 2021

(54) FLAME-RETARDANT POLYAMIDE COMPOSITIONS HAVING HIGH HEAT DISTORTION RESISTANCE AND USE THEREOF

(71) Applicant: CLARIANT PLASTICS & COATINGS LTD, Muttenz (CH)

(72) Inventors: Harald BAUER, Kerpen (DE); Sebastian HÖROLD, Diedorf (DE); Martin SICKEN, Köln (DE)

(73) Assignee: CLARIANT PLASTICS & COATINGS LTD, Muttenz (CH)

(21) Appl. No.: 16/630,494

(22) PCT Filed: Jul. 6, 2018
(86) PCT No.: PCT/EP2018/068321

§ 371 Date: Jan. 13, 2020

(30) Foreign Application Priority Data
Jul. 14, 2017 (DE) 10 2017 212 098.3

(51) Int. Cl. C08K 5/5313; C08K 7/14; C08K 5/5317; C08K 5/00

(52) U.S. Cl. CPC C08K 5/5313; C08K 7/14; C08K 2201/003; C08K 5/0066; C08K 2201/004; C08K 5/5317

(57) ABSTRACT

What are described are flame-retardant polyamide compositions having a heat deflection temperature HDT-A of at least 280° C., comprising
polyamide having a melting point of not less than 290° C. as component A,
fillers and/or reinforcers as component B,
phosphinic salt of the formula (I) as component C

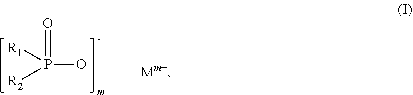

in which R₁ and R₂ are ethyl,
M is Al, Fe, TiOₚ or Zn,
m is 2 to 3, and
p=(4−m)/2
compound selected from the group of the Al, Fe, TiOₚ and Zn salts of ethylbutylphosphinic acid, of dibutylphosphinic acid, of ethylhexylphosphinic acid, of butylhexylphosphinic acid and/or of dihexylphosphinic acid as component D, and
monoethylphosphinic salt of the formula II as component E

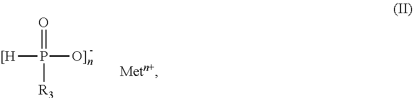

in which R₃ is ethyl,
Met is Al, Fe, TiO_{q} or Zn,
n is 2 to 3, and
q=(4−n)/2.

The polyamide compositions can be used for production of fibers, films and shaped bodies, especially for applications in the electricals and electronics sector.

The present invention relates to flame-retardant polyamide compositions and the moldings produced therefrom that are notable for very good flame retardancy and a high heat deflection temperature (HDT).

Combustible plastics generally have to be equipped with flame retardants in order to be able to attain the high flame retardancy demands made by the plastics processors and in some cases by the legislator. Preferably
for environmental reasons as well—nonhalogenated flame retardant systems that form only a low level of smoke gases, if any, are used.

Among these flame retardants, the salts of phosphinic acids (phosphinates) have been found to be particularly effective for thermoplastic polymers (DE 2 252 258 A and DE 2 447 727 A).

In addition, there are known synergistic combinations of phosphinates with particular nitrogen-containing compounds which have been found to be more effective as flame retardants in a whole series of polymers than the phosphinates alone (WO-2002/28953 A1, and also DE 197 34 437 A1 and DE 197 37 727 A1).

U.S. Pat. No. 7,420,007 B2 discloses that dialkylphosphinates containing a small amount of selected telomers as flame retardant are suitable for polymers, the polymer being subject only to quite a minor degree of degradation on incorporation of the flame retardant into the polymer matrix.

Flame retardants frequently have to be added in high dosages in order to ensure sufficient flame retardancy of the plastic according to international standards. Due to their chemical reactivity, which is required for flame retardancy at high temperatures, flame retardants, particularly at higher dosages, can impair the processing stability of plastics. This may result in increased polymer degradation, crosslinking reactions, outgassing or discoloration.

WO 2014/135256 A1 discloses polyamide molding compounds having distinctly improved thermal stability, reduced tendency to migration and good electrical and mechanical properties.

However, there has to date been a lack of flame-retardant phosphinate-containing polyamide compositions that achieve all the properties required simultaneously, such as good electrical values (GWFI, CTI), excellent heat distortion resistance (HDT-A) and effective flame retardancy, characterized by minimum afterflame times (UL-94).

It was therefore an object of the present invention to provide flame-retardant polyamide compositions based on phosphinate-containing flame retardant systems which have all the aforementioned properties at the same time and which especially have good electrical values and high heat distortion resistance, and also high flame retardancy, characterized by minimum afterflame times.

The invention provides flame-retardant polyamide compositions having a heat deflection temperature HDT-A of at least 280° C., comprising
polyamide having a melting point of not less than 290° C., preferably of not less than 300° C., as component A,
fillers and/or reinforcers, preferably glass fibers, as component B,
diethylphosphinic salt of the formula (I) as component C

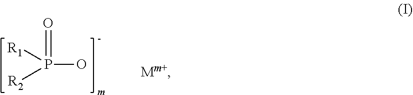

in which R₁ and R₂ are ethyl,
M is Al, Fe, TiOₚ or Zn,
m is 2 to 3, preferably 2 or 3, and
p=(4−m)/2
compound selected from the group of the Al, Fe, TiOₚ and Zn salts of ethylbutylphosphinic acid, of dibutylphosphinic acid, of ethylhexylphosphinic acid, of butylhexylphosphinic acid and/or of dihexylphosphinic acid as component D, and
monoethylphosphinic salt of the formula II as component E

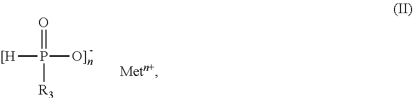

in which R₃ is ethyl,
Met is Al, Fe, TiO_{q} or Zn,
n is 2 to 3, preferably 2 or 3, and
q=(4−n)/2.

In the polyamide composition of the invention, the proportion of component A is typically 25% to 95% by weight, preferably 25% to 75% by weight.

In the polyamide composition of the invention, the proportion of component B is typically 1% to 45% by weight, preferably 20% to 40% by weight.

In the polyamide composition of the invention, the proportion of component C is typically 0.75% to 30% by weight, preferably 5% to 20% by weight.

In the polyamide composition of the invention, the proportion of component D is typically 0.01% to 3% by weight, preferably 0.05% to 1.5% by weight.

In the polyamide composition of the invention, the proportion of component E is typically 0.01% to 2% by weight, preferably 0.01% to 0.5% by weight.

These percentages for the proportions of components A to E are based on the total amount of the polyamide composition.

Preference is given to flame-retardant polyamide compositions in which
the proportion of component A is 25% to 95% by weight,
the proportion of component B is 1% to 45% by weight,
the proportion of component C is 0.75% to 30% by weight,
the proportion of component D is 0.01% to 3% by weight, and
the proportion of component E is 0.01% to 2% by weight,
   where the percentages are based on the total amount of the polyamide composition.

Particular preference is given to flame-retardant polyamide compositions in which
the proportion of component A is 25% to 75% by weight,
the proportion of component B is 20% to 40% by weight,
the proportion of component C is 5% to 20% by weight,
the proportion of component D is 0.05% to 1.5% by weight, and
the proportion of component E is 0.01% to 0.5% by weight,
   where the percentages are based on the total amount of the polyamide composition.

Salts of component C that are used with preference are those in which M^{m+} is Zn²⁺, Fe³⁺ or especially Al³⁺.

Salts of component D that are used with preference are zinc, iron or especially aluminum salts.

Salts of component E that are used with preference are those in which Metⁿ⁺ is Zn²⁺, Fe³⁺ or especially Al³⁺.

Preference is given to flame-retardant polyamide compositions in which M and Met are Al, m and n are 3, and in which the compounds of component D take the form of aluminum salts.

In a preferred embodiment, the above-described flame-retardant polyamide compositions comprise phosphonic salts of the formula (IX) as component F

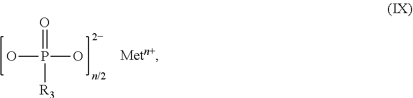

in which R₃ is ethyl,
Met is Al, Fe, TiO_{q} or Zn,
n is 2 to 3, preferably 2 or 3, and
q=(4−n)/2.

Component F is preferably present in an amount of 0.005% to 1% by weight, especially in an amount of 0.01% to 0.6% by weight, based on the total amount of the polyamide composition.

In a further preferred embodiment, the above-described flame-retardant polyamide compositions comprise inorganic phosphonates as a further component G.

The use of the inorganic phosphonates used in accordance with the invention as component G or else of salts of phosphorous acid (phosphites) as flame retardants is known. For instance, WO 2012/045414 A1 discloses flame retardant combinations comprising, as well as phosphinic salts, also salts of phosphorous acid (=phosphites).

Preferably, the inorganic phosphonate (component G) conforms to the formula (IV) or (V)

[(HO)PO₂]²⁻_{p/2}Kat^{p+} (IV)

[(HO)₂PO]⁻ₚKat^{p+} (V)

in which Kat is a p-valent cation, especially a cation of an alkali metal or alkaline earth metal, an ammonium cation and/or a cation of Fe, Zn or especially of Al, including the cations Al(OH) or Al(OH)₂, and p is 1, 2, 3 or 4.

Preferably, the inorganic phosphonate (component G) is aluminum phosphite [Al(H₂PO₃)₃], secondary aluminum phosphite [Al₂(HPO₃)₃], basic aluminum phosphite [Al(OH)(H₂PO₃)₂*2aq], aluminum phosphite tetrahydrate [Al₂(HPO₃)₃*4aq], aluminum phosphonate, Al₇(HPO₃)₉(OH)₆(1,6-hexanediamine)_{1.5}*12H₂O, Al₂(HPO₃)³*XAl₂O₃*nH₂O where x=2.27-1 and/or Al₂H₆P₁₆O₁₈.

The inorganic phosphonate (component G) preferably also comprises aluminum phosphites of the formulae (VI), (VII) and/or (VIII)

Al₂(HPO₃)₃x(H₂O)_{q} (VI)

where q is 0 to 4,

Al_{2.00}M_{z}(HPO₃)_{y}(OH)ᵥx(H₂O)_{w} (VII)

where M represents alkali metal cations, z is 0.01 to 1.5 and y is 2.63 to 3.5 and v is 0 to 2 and w is 0 to 4;

Al_{2.00}(HPO₃)ᵤ(H₂PO₃)ₜx(H₂O)ₛ (VIII)

where u is 2 to 2.99 and t is 2 to 0.01 and s is 0 to 4, and/or
aluminium phosphite [Al(H2PO₃)₃], secondary aluminum phosphite [Al₂(HPO₃)₃], basic aluminum phosphite [Al(OH)(H₂PO₃)₂+2aq], aluminum phosphite tetrahydrate [Al₂(HPO₃)₃*4aq], aluminum phosphonate, Al₇(HPO₃)₉(OH)₆(1,6-hexanediamine)_{1.5}*12H₂O, Al₂(HPO₃)³*XAl₂O₃*nH₂O where x=2.27−1 and/or Al₄H₆P₁₆O₁₈.

Preferred inorganic phosphonates (component G) are salts that are insoluble or sparingly soluble in water.

Particularly preferred inorganic phosphonates are aluminum, calcium and zinc salts.

More preferably, component G is a reaction product of phosphorous acid and an aluminum compound.

Particularly preferred components G are aluminum phosphites having CAS numbers 15099-32-8, 119103-85-4, 220689-59-8, 56287-23-1, 156024-71-4, 71449-76-8 and 15099-32-8.

The aluminum phosphites used with preference are prepared by reaction of an aluminum source with a phosphorus source and optionally a template in a solvent at 20-200° C. over a period of time of up to 4 days. For this purpose, aluminum source and phosphorus source are mixed for 1-4 h, heated under hydrothermal conditions or at reflux, filtered off, washed and dried, for example at 110° C.

Preferred aluminum sources are aluminum isopropoxide, aluminum nitrate, aluminum chloride, aluminum hydroxide (e.g. pseudoboehmite).

Preferred phosphorus sources are phosphorous acid, (acidic) ammonium phosphite, alkali metal phosphites or alkaline earth metal phosphites.

Preferred alkali metal phosphites are disodium phosphite, disodium phosphite hydrate, trisodium phosphite, potassium hydrogenphosphite.

A preferred disodium phosphite hydrate is Brüggolen® H10 from Brüggemann. Preferred templates are 1,6-hexanediamine, guanidine carbonate or ammonia.

A preferred alkaline earth metal phosphite is calcium phosphite.

The preferred ratio of aluminum to phosphorus to solvent is 1:1:3.7 to 1:2.2:100 mol. The ratio of aluminum to template is 1:0 to 1:17 mol. The preferred pH of the reaction solution is 3 to 9. A preferred solvent is water.

In the application, particular preference is given to using the same salt of phosphinic acid as of phosphorous acid, i.e., for example, aluminum diethylphosphinate together with aluminum phosphite or zinc diethylphosphinate together with zinc phosphite.

In a preferred embodiment, the above-described flame-retardant polyester compositions comprise, as component G, a compound of the formula (III)

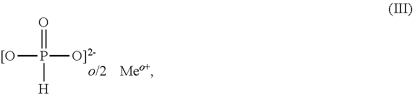

in which Me is Fe, TiOᵣ, Zn or especially Al,
o is 2 to 3, preferably 2 or 3, and
r=(4−o)/2.

Compounds of the formula III that are used with preference are those in which Me^{o+} is Zn²⁺, Fe³⁺ or especially Al³⁺.

Component G is preferably present in an amount of 0.005% to 10% by weight, especially in an amount of 0.02% to 5% by weight, based on the total amount of the polyamide composition.

The flame retardant polymer compositions of the invention have a high heat deflection temperature (HDT-A) according to DIN EN ISO 75-3 of at least 280° C., preferably of at least 290° C. and more preferably of at least 300° C.

Preference is given to flame-retardant polyamide compositions of the invention that have a comparative tracking index, measured according to International Electrotechnical Commission Standard IEC-60112/3, of not less than 500 volts.

Likewise preferred flame-retardant polyamide compositions of the invention attain a V-0 assessment according to UL-94, especially measured on moldings of thickness 3.2 mm to 0.4 mm.

The polyamide compositions of the invention comprise, as component A, one or more thermoplastic polyamides having a melting point of not less than 290° C. The melting point is determined by means of differential scanning calorimetry (DSC) at a heating rate of 10 K/second.

According to Hans Domininghaus in “Die Kunststoffe and ihre Eigenschaften” [The Polymers and their Properties], 5th edition (1998), page 14, thermoplastic polyamides are polyamides wherein the molecular chains have no side branches or else varying numbers of side branches of greater or lesser length, and which soften when heated and are virtually infinitely shapable.

The polyamides preferred in accordance with the invention may be prepared by various methods and be synthesized from very different starting materials and, in the specific application case, may be modified alone or in combination with processing auxiliaries, stabilizers or else polymeric alloy partners, preferably elastomers, to give materials having specifically established combinations of properties. Also suitable are blends with proportions of other polymers, preferably of polyethylene, polypropylene, ABS, in which case it is optionally possible to use one or more compatibilizers. The properties of the polyamides can be improved by addition of elastomers, for example with regard to impact resistance, especially when the polyamides are reinforced polyamides. The multitude of possible combinations enables a very large number of products having a wide variety of different properties.

A multitude of procedures have become known for preparation of polyamides, using different monomer units, various chain transfer agents for establishment of a desired molecular weight or else monomers having reactive groups for intended later aftertreatments according to the end product desired.

The processes of industrial relevance for preparation of polyamides usually proceed by polycondensation in the melt. This is also understood to include the hydrolytic polymerization of lactams as a polycondensation.

Polyamides for use with preference as component A are semicrystalline and aromatic or semiaromatic polyamides which can be prepared proceeding from diamines and dicarboxylic acids and/or lactams having at least 5 ring members or corresponding amino acids.

Useful reactants include mainly aromatic dicarboxylic acids, preferably isophthalic acid and terephthalic acid or the polyamide-forming derivatives thereof, such as salts, which are used alone or in combination with aliphatic dicarboxylic acids or the polyamide-forming derivatives thereof, preferably adipic acid, 2,2,4- and 2,4,4-trimethyladipic acid, azelaic acid and/or sebacic acid, together with aliphatic and/or aromatic diamines, preferably tetramethylenediamine, hexamethylenediamine, nonane-1,9-diamine, 2,2,4- and 2,4,4-trimethylhexamethylenediamine, the isomeric diaminodicyclohexylmethanes, diaminodicyclohexylpropanes, bis(aminomethyl)cyclohexanes, phenylenediamines and or xylylenediamines, and/or with aminocarboxylic acids, preferably aminocaproic acid, or the corresponding lactams. Copolyamides formed from two or more of the monomers mentioned are included.

Also particularly suitable are aromatic and semiaromatic polyamide, i.e. compounds in which at least some of the repeat units have been formed from aromatic structural units. These polymers can optionally be used in combination with smaller amounts, such as up to 20% by weight, based on the amount of polyamide, of aliphatic polyamides, especially PA 6 and/or PA 6,6, if this achieves a heat deflection temperature of the molding compound or of the shaped body produced therefrom of at least 290° C.

Preferentially suitable aromatic polyamides are those based on xylylenediamine and adipic acid; or polyamides prepared from hexamethylenediamine and iso- and/or terephthalic acid and optionally an elastomer as a modifier, for example poly-2,4,4-trimethylhexamethyleneterephthalamide or poly-m-phenyleneisophthalamide, block copolymers of the aforementioned polyamides with polyolefins, olefin copolymers, ionomers or chemically bound or grafted elastomers, or with polyethers, for example with polyethylene glycol, polypropylene glycol or polytetramethylene glycol. In addition, EPDM- or ABS-modified polyamides or copolyamides, and polyamides condensed during processing (“RIM polyamide systems”).

In a preferred embodiment, component A is an aromatic or semiaromatic polyamide or a mixture of two or more aromatic or semiaromatic polyamides or a mixture of nylon-6,6 and one or more aromatic or semiaromatic polyamides.

Standard additives, especially demolding agents, stabilizers and/or flow auxiliaries, may be mixed into the melt or applied to the surface of polymers to be used in addition to the thermoplastic polyamide in a preferred embodiment. Starting materials for the thermoplastic polyamides of component A may have a synthetic origin, for example from petrochemical raw materials, and/or may have originated from renewable raw materials via chemical or biochemical processes.

Fillers and/or preferably reinforcers are used as component B, preferably glass fibers. It is also possible to use mixtures of two or more different fillers and/or reinforcers.

Preferred fillers are mineral particulate fillers based on talc, mica, silicate, quartz, titanium dioxide, wollastonite, kaolin, amorphous silicas, nanoscale minerals, more preferably montmorillonites or nanoboehmites, magnesium carbonate, chalk, feldspar, glass beads and/or barium sulfate. Particular preference is given to mineral particulate fillers based on talc, wollastonite and/or kaolin.

Particular preference is further also given to using acicular mineral fillers. Acicular mineral fillers are understood in accordance with the invention to mean a mineral filler having highly pronounced acicular character. Preference is given to acicular wollastonites. Preferably, the mineral has a length to diameter ratio of 2:1 to 35:1, more preferably of 3:1 to 19:1, especially preferably of 4:1 to 12:1. The average particle size of the acicular mineral fillers used in accordance with the invention as component B is preferably less than 20 μm, more preferably less than 15 μm, especially preferably less than 10 μm, determined with a CILAS granulometer.

Components B used with preference in accordance with the invention are reinforcers. These may, for example, be reinforcers based on carbon fibers and/or on glass fibers.

The filler and/or reinforcer may, in a preferred embodiment, have been surface-modified, preferably with an adhesion promoter or an adhesion promoter system, more preferably a silane-based adhesion promoter system. Especially in the case of use of glass fibers, in addition to silanes, it is also possible to use polymer dispersions, film formers, branching agents and/or glass fiber processing auxiliaries.

The glass fibers used with preference in accordance with the invention as component B may be short glass fibers and/or long glass fibers. Short or long glass fibers used may be chopped fibers. Short glass fibers may also be used in the form of ground glass fibers. In addition, glass fibers may also be used in the form of continuous fibers, for example in the form of rovings, monofilaments, filament yarns or threads, or glass fibers may be used in the form of textile fabrics, for example of a glass weave, a glass braid or a glass mat.

Typical fiber lengths for short glass fibers prior to incorporation into the polyamide matrix are within the range from 0.05 to 10 mm, preferably from 0.1 to 5 mm. After incorporation into the polyamide matrix, the length of the glass fibers has decreased. Typical fiber lengths for short glass fibers after incorporation into the polyamide matrix are within the range from 0.01 to 2 mm, preferably from 0.02 to 1 mm.

The diameters of the individual fibers may vary within wide ranges. Typical diameters of the individual fibers vary within the range from 5 to 20 μm.

The glass fibers may have any desired cross-sectional forms, for example round, elliptical, n-gonal or irregular cross sections. It is possible to use glass fibers having mono- or multilobal cross sections.

Glass fibers may be used in the form of continuous fibers or in the form of chopped or ground glass fibers.

The glass fibers themselves, irrespective of their cross-sectional area and length, may be selected, for example, from the group of the E glass fibers, A glass fibers, C glass fibers, D glass fibers, M glass fibers, S glass fibers, R glass fibers and/or ECR glass fibers, particular preference being given to the E glass fibers, R glass fibers, S glass fibers and ECR glass fibers. The glass fibers have preferably been provided with a size, preferably containing polyurethane as film former and aminosilane as adhesion promoter.

E glass fibers used with particular preference have the following chemical composition: SiO₂ 50-56%; Al₂O₃ 12-16%; CaO 16-25%; MgO≤6%; B₂O₃ 6-13%; F≤0.7%; Na₂O 0.3-2%; K₂O 0.2-0.5%; Fe₂O₃ 0.3%.

R glass fibers used with particular preference have the following chemical composition: SiO₂ 50-65%; Al₂O₃ 20-30%; CaO 6-16%; MgO 5-20%; Na₂O 0.3-0.5%; K₂O 0.05-0.2%; Fe₂O₃ 0.2-0.4%, TiO₂ 0.1-0.3%.

ECR glass fibers used with particular preference have the following chemical composition: SiO₂ 57.5-58.5%; Al₂O₃ 17.5-19.0%; CaO 11.5-13.0%; MgO 9.5-11.5.

The salts of diethylphosphinic acid used as component C in accordance with the invention are known flame retardants for polymeric molding compounds.

Salts of diethylphosphinic acid with proportions of the monoethylphosphinic salts used in accordance with the invention as component E are also known flame retardants. These combinations of substances are described, for example, in DE 102010018682 A1.

The salts of diethylphosphinic acid of component C that are used in accordance with the invention contain small amounts of salts of component D and optionally salts of monoethylphosphonic acid of component F, for example up to 10% by weight of component D, preferably 0.01% to 6% by weight, and especially 0.2% to 2.5% by weight thereof, and up to 25% by weight of component F, preferably 1% to 20% by weight, and especially 2% to 15% by weight thereof, based on the amount of components C, D and E.

The salts of phosphinic acid derivatives used in accordance with the invention as component D are likewise known as additions to diethylphosphinates in flame retardants for polymeric molding compounds, for example from U.S. Pat. No. 7,420,007 B2.

The salts of ethylphosphonic acid used in accordance with the invention as component F are likewise known as additions to diethylphosphinates in flame retardants for polymeric molding compounds, for example from WO 2016/065971 A1.

In a further preferred embodiment, components C, D and E are in particulate form, where the median particle size (d₅₀) is 1 to 100 μm.

The polyamide compositions of the invention may also comprise further additives as component H. Preferred components G in the context of the present invention are antioxidants, UV stabilizers, gamma ray stabilizers, hydrolysis stabilizers, costabilizers for antioxidants, antistats, emulsifiers, nucleating agents, plasticizers, processing auxiliaries, impact modifiers, dyes, pigments and/or further flame retardants other than components C, D, E, F and G.

The further additives are known per se as additions to polyamide compositions and can be used alone or in a mixture or in the form of masterbatches.

The aforementioned components A, B, C, D, E and optionally F and/or G and/or H may be processed in a wide variety of different combinations to give the flame-retardant polyamide composition of the invention. For instance, it is possible, at the start or at the end of the polycondensation or in a subsequent compounding operation, to mix the components into the polyamide melt. In addition, there are processing operations in which individual components are not added until a later stage. This is practiced especially in the case of use of pigment or additive masterbatches. There is also the possibility of applying components, particularly those in pulverulent form, to the polymer pellets, which may be warm as a result of the drying operation, by drum application.

It is also possible to combine two or more of the components of the polyamide compositions of the invention by mixing before they are introduced into the polyamide matrix. It is possible here to use conventional mixing units in which the components are mixed in a suitable mixer, for example at 0 to 300° C. for 0.01 to 10 hours.

It is also possible to use two or more of the components of the polyamide compositions of the invention to produce pellets that can then be introduced into the polyamide matrix.

For this purpose, two or more components of the polyamide composition of the invention can be processed with pelletizing aids and/or binders in a suitable mixer or a dish pelletizer to give pellets.

The crude product formed at first can be dried in a suitable drier or heat-treated to further increase the grain size.

The polyamide composition of the invention or two or more components thereof may, in one embodiment, be produced by roll compaction.

The polyamide composition of the invention or two or more components thereof may, in one embodiment, be produced by subjecting the ingredients to mixing, extruding, chopping (and optionally crushing and classifying) and drying (and optionally coating).

The polyamide composition of the invention or two or more components thereof may, in one embodiment, be produced by spray granulation.

The flame-retardant polymer molding compound of the invention is preferably in pellet form, for example in the form of an extrudate or compound. The pelletized material is preferably in cylindrical form with a circular, elliptical or irregular footprint, in bead form, in cushion form, in cube form, in cuboid form or in prism form.

Typical length-to-diameter ratios of the pelletized material are 1:50 to 50:1, preferably 1:5 to 5:1.

The pelletized material preferably has a diameter of 0.5 to 15 mm, more preferably of 2 to 3 mm, and preferably a length of 0.5 to 15 mm, more preferably of 2 to 5 mm.

The invention also provides moldings produced from the above-described flame-retardant polyamide composition comprising components A, B, C, D, E and optionally component F and/or component G and/or component H.

The moldings of the invention may be in any desired shape and form. Examples of these are fibers, films or shaped bodies obtainable from the flame-retardant polyamide molding compounds of the invention by any desired shaping processes, especially by injection molding or extrusion.

The flame-retardant shaped polyamide bodies of the invention can be produced by any desired shaping methods. Examples of these are injection molding, pressing, foam injection molding, internal gas pressure injection molding, blow molding, film casting, calendering, laminating or coating at relatively high temperatures with the flame-retardant polyamide molding compound.

The moldings are preferably injection moldings or extrudates.

The flame-retardant polyamide compositions of the invention are suitable for production of fibers, films and shaped bodies, especially for applications in the electricals and electronics sector.

The invention preferably relates to the use of the flame-retardant polyamide compositions of the invention in or for plug connectors, current-bearing components in power distributors (residual current protection), printed circuit boards, potting compounds, plug connectors, circuit breakers, lamp housings, LED housings, capacitor housings, coil elements and ventilators, grounding contacts, plugs, in/on printed circuit boards, housings for plugs, cables, flexible circuit boards, charging cables for mobile phones, motor covers or textile coatings.

The invention likewise preferably relates to the use of the flame-retardant polyamide compositions of the invention for production of shaped bodies in the form of components for the electrics/electronics sector, especially for parts of printed circuit boards, housings, films, wires, switches, distributors, relays, resistors, capacitors, coils, lamps, diodes, LEDs, transistors, connectors, regulators, memory elements and sensors, in the form of large-area components, especially of housing components for switchgear cabinets and in the form of components of complicated configuration with demanding geometry.

The wall thickness of the shaped bodies of the invention may typically be up to 10 mm. Particularly suitable shaped bodies are those having a wall thickness of less than 1.5 mm, more preferably a wall thickness of less than 1 mm and especially preferably a wall thickness of less than 0.5 mm.

The examples which follow elucidate the invention without restricting it.

### 1. Components Used

Commercial polyamides (component A or comparison):
Nylon-6T/6,6 (melting range of 310−320° C.): Vestamid® HAT plus 1000 (Evonik)
Nylon-6T/6I (amorphous): Grivory® G21, (EMS)
Nylon-6,6 (PA 6,6-GV; melting range of 255−260° C.): Ultramid® A27 (BASF)

Glass fibers (component B):
PPG HP 3610 glass fibers, diameter 10 μm, length 4.5 mm (from PPG, NL)

Flame retardant FM 1 (component C):
aluminum salt of diethylphosphinic acid prepared in analogy to example 1 of DE 196 07 635 A1

Flame retardant FM 2 (components C and D):
aluminum salt of diethylphosphinic acid containing 0.9 mol % of aluminum ethylbutylphosphinate prepared analogy to example 1 of DE 10 2014 001 222 A1

Flame retardant FM 3 (components C, D and F):
aluminum salt of diethylphosphinic acid containing 0.9 mol % of aluminum ethylbutylphosphinate and 0.5 mol % of aluminum ethylphosphonate prepared according to example 3 of U.S. Pat. No. 7,420,007 B2

Flame retardant FM 4 (components C, D and F):
aluminum salt of diethylphosphinic acid containing 2.7 mol % of aluminum ethylbutylphosphinate and 0.8 mol % of aluminum ethylphosphonate prepared according to example 4 of U.S. Pat. No. 7,420,007 B2

Flame retardant FM 5 (components C, D and F):
aluminum salt of diethylphosphinic acid containing 0.5 mol % of aluminum ethylbutylphosphinate and 0.05 mol % of aluminum ethylphosphonate prepared by the process according to U.S. Pat. No. 7,420,007 B2

Flame retardant FM 6 (components C, D and F):
aluminum salt of diethylphosphinic acid containing 10 mol % of aluminum ethylbutylphosphinate and 5 mol % of aluminum ethylphosphonate prepared by the process according to U.S. Pat. No. 7,420,007 B2

Flame retardant FM 7 (component E):
aluminum salt of monoethylphosphinic acid prepared according to example 18 of DE 10 2010 018 682 A1

Flame retardant FM 8 (component G):
aluminum salt of phosphonic acid prepared according to example 1 of DE-102011120218A1
   2. Production, Processing and Testing of Flame-Retardant Polyamide Molding compounds

The flame retardant components were mixed with one another in the ratios specified in the tables and incorporated via the side intake of a twin-screw extruder (Leistritz ZSE 27/44D) at temperatures of 310 to 330° C. The glass fibers were added via a second side intake. The homogenized polymer strand was drawn off, cooled in a water bath and then pelletized.

After sufficient drying, the molding compositions were processed to test specimens on an injection molding machine (Arburg 320 C Allrounder) at melt temperatures of 300 to 320° C., and tested and classified for flame retardancy using the UL 94 test (Underwriter Laboratories). As well as the classification, the afterflame time was also reported.

The comparative tracking index of the moldings was determined according to International Electrotechnical Commission Standard IEC-60112/3.

The glow wire flammability index (GWIT index) was determined according to standard IEC-60695-2-12.

The heat deflection temperature (HDT-A) was ascertained according to DIN EN ISO 75-3.

In the determination of the HDT, a standard specimen with rectangular cross section is subjected to three-point bending under constant load. According to the specimen height, what is called an edge fibre stress σ_{f} of 1.80 (method A), 0.45 (method B) or 8.00 N/mm² (method C) is achieved by applying weights and/or springs of force F=2σfbh23L {\displaystyle F={\frac {2\sigma_{\rm {f}}bh\hat{ }{2}}{3L}}}. Subsequently, the stressed samples are subjected to heating at a constant heating rate of 120 K/h (or 50 K/h). If the bending of the sample reaches an edge fibre elongation of 0.2%, the corresponding temperature is the HDT value.

The flowability of the molding compositions was determined by finding the melt volume flow rate (MVR) at 275° C./2.16 kg. A sharp rise in the MVR value indicates polymer degradation.

To determine exudation, the polymer strand is stored at 70° C. at 100% humidity for 14 days and then visually assessed. In this assessment: 1=no exudation, 2=low exudation, 3=distinct exudation, 4=significant exudation.

All tests in the respective series, unless stated otherwise, were performed under identical conditions (such as temperature programs, screw geometry and injection molding parameters) for comparability.

### EXAMPLES 1-6 AND COMPARATIVE EXAMPLES C1-08 WITH PA 6T/6,6

The results of the experiments with PA 6T/6,6 molding compounds are listed in the examples adduced in the table which follows. All amounts are reported as % by weight and are based on the polyamide molding compound including the flame retardants, additives and reinforcers.

TABLE 1
PA 6T/6,6 GF 30 test results (1-6 inventive; C1-C8 comparisons)

| Example No. | 1 | 2 | 3 | 4 | 5 | 6 | C1 | C2 | C3 | C4 | C5 | C6 | C7 | C8 |
|---|---|---|---|---|---|---|---|---|---|---|---|---|---|---|
| A: PA 6T/6,6 | 54.5 | 54.5 | 54.5 | 54.1 | 54.5 | 54.5 | 55 | 55 | 55 | 54.5 | 55 | 55 | 55 | 55 |
| B: glass fibers | 30 | 30 | 30 | 30 | 30 | 30 | 30 | 30 | 30 | 30 | 30 | 30 | 30 | 30 |
| HP3610 | | | | | | | | | | | | | | |
| C: FM 1 | — | — | — | — | — | — | 15 | 15 | — | 15 | — | — | — | — |
| C + D: FM 2 | 15 | — | — | — | — | 12 | — | — | 15 | — | — | — | — | — |
| C + D + F: | — | 15 | — | — | — | — | — | — | — | — | 15 | — | — | — |
| FM 3 | | | | | | | | | | | | | | |
| C + D + F: | — | — | 15 | — | — | — | — | — | — | — | — | 15 | — | — |
| FM 4 | | | | | | | | | | | | | | |
| C + D + F: | — | — | — | 15 | — | — | — | — | — | — | — | — | 15 | — |
| FM 5 | | | | | | | | | | | | | | |
| C + D + F: | — | — | — | — | 15 | — | — | — | — | — | — | — | — | 15 |
| FM 6 | | | | | | | | | | | | | | |
| E: FM 7 | 0.5 | 0.5 | 0.5 | 0.9 | 0.5 | 0.5 | 0.5 | — | — | 0.5 | — | — | — | — |
| G: FM 8 | — | — | — | — | — | 3 | — | — | — | — | — | — | — | — |
| HDT-A [ ° C.] | 307 | 305 | 307 | 299 | 304 | 306 | 299 | 297 | 300 | 301 | 303 | 298 | 299 | 300 |
| UL 94 0.4 mm/ | V-0/19 | V-0/10 | V-0/12 | V-0/17 | V-0/23 | V-0/08 | V-1/58 | V-1/69 | V-0/48 | V-1/77 | V-1/67 | V-0/43 | V-1/67 | V-1/87 |
| time [sec.] | | | | | | | | | | | | | | |
| GWFI [° C.] | 960 | 960 | 960 | 960 | 960 | 960 | 960 | 960 | 960 | 960 | 960 | 960 | 900 | 960 |
| CTI [volts] | 600 | 600 | 600 | 600 | 600 | 600 | 550 | 500 | 550 | 550 | 500 | 550 | 550 | 550 |
| MVR [cm³/ | 12 | 11 | 12 | 14 | 11 | 9 | 11 | 17 | 19 | 18 | 18 | 19 | 18 | 19 |
| 10 min.] | | | | | | | | | | | | | | |
| Exudation | 1 | 1 | 1 | 1 | 1 | 1 | 2 | 2 | 2 | 2 | 2 | 2 | 2 | 2 |

Only with the inventive mixtures is there attainment of a high HDT-A, UL 94 V-0, GFWI 960, low exudation and low polymer degradation, discernible by low MVR.

### EXAMPLES 7-12 AND COMPARATIVE EXAMPLES C9-C16 WITH PA 6T/6I

The results of the experiments with PA 6T/6I molding compounds are listed in the examples adduced in the table which follows. All amounts are reported as % by weight and are based on the polyamide molding compound including the flame retardants, additives and reinforcers.

TABLE 2
PA 6T/6I GF 30 test results (7-12 inventive; C9-C16 comparisons)

| Example No. | 7 | 8 | 9 | 10 | 11 | 12 | C9 | C10 | C11 | C12 | C13 | C14 | C15 | C16 |
|---|---|---|---|---|---|---|---|---|---|---|---|---|---|---|
| A: PA 6T/6,6 | 54.5 | 54.5 | 54.5 | 54.5 | 54.5 | 54.5 | 54.5 | 55 | 55 | 54.5 | 55 | 55 | 55 | 55 |
| B: glass fibers | 30 | 30 | 30 | 30 | 30 | 30 | 30 | 30 | 30 | 30 | 30 | 30 | 30 | 30 |
| HP3610 | | | | | | | | | | | | | | |
| C: FM 1 | — | — | — | — | — | — | 15 | 15 | — | 15 | — | — | — | — |
| C + D: FM 2 | 15 | — | — | — | — | 13 | — | — | 15 | — | — | — | — | — |
| C + D + F: | — | 15 | — | — | — | — | — | — | — | — | 15 | — | — | — |
| FM 3 | | | | | | | | | | | | | | |
| C + D + F: | — | — | 15 | — | — | — | — | — | — | — | — | 15 | — | — |
| FM 4 | | | | | | | | | | | | | | |
| C + D + F: | — | — | — | 15 | — | — | — | — | — | — | — | — | 15 | — |
| FM 5 | | | | | | | | | | | | | | |
| C + D + F: | — | — | — | — | 15 | — | — | — | — | — | — | — | — | 15 |
| FM 6 | | | | | | | | | | | | | | |
| E: FM 7 | 0.5 | 0.5 | 0.5 | 0.5 | 0.5 | 0.5 | 0.5 | — | — | 0.5 | — | — | — | — |
| G: FM 8 | — | — | — | — | — | 2 | — | — | — | — | — | — | — | — |
| HDT-A [ ° C.] | 307 | 306 | 308 | 306 | 301 | 303 | 298 | 289 | 296 | 287 | 300 | 289 | 299 | 299 |
| UL 94 0.4 mm/ | V-0/30 | V-0/22 | V-0/28 | V-0/31 | V-0/15 | V-0/19 | V-1/76 | V-1/53 | V-0/48 | V-1/98 | V-1/78 | V-1/84 | V-0/49 | V-1/56 |
| time [sec.] | | | | | | | | | | | | | | |
| GWFI [° C.] | 960 | 960 | 960 | 960 | 960 | 960 | 960 | 900 | 960 | 960 | 900 | 850 | 960 | 960 |
| CTI [volts] | 600 | 600 | 600 | 600 | 600 | 600 | 600 | 550 | 550 | 500 | 575 | 550 | 500 | 550 |
| MVR [cm³/ | 7 | 8 | 6 | 9 | 7 | 8 | 12 | 18 | 15 | 17 | 23 | 14 | 13 | 18 |
| 10 min.] | | | | | | | | | | | | | | |
| Exudation | 1 | 1 | 1 | 1 | 1 | 1 | 1 | 1 | 2 | 2 | 2 | 2 | 2 | 2 |

Only with the inventive mixtures is there attainment of a high HDT-A, UL 94 V-0, GFWI 960, low exudation and low polymer degradation, discernible by low MVR.

### COMPARATIVE EXAMPLES C17-C23 WITH PA 6,6

The results of the experiments with PA 6,6 molding compounds are listed in the examples adduced in the table which follows. All amounts are reported as % by weight and are based on the polyamide molding compound including the flame retardants, additives and reinforcers.

In the production of the molding compounds, a Leistritz ZSE 27/44D twin-screw extruder was likewise used. However, the additives were incorporated into the PA 6,6 at temperatures of 260 to 310° C. The glass fibers were added via a second side intake. The homogenized polymer strand was drawn off, cooled in a water bath and then pelletized.

After sufficient drying, the molding compositions were processed to test specimens on an injection molding machine (Arburg 320 C Allrounder) at melt temperatures of 250 to 320° C., and then tested and classified.

TABLE 3
PA 6,6 GF 30 test results (C17-C23 comparisons)

| Example No. | C17 | C18 | C19 | C20 | C21 | C22 | C23 |
|---|---|---|---|---|---|---|---|
| A: PA 6T/6,6 | 49.5 | 49.5 | 49.5 | 49.5 | 49.5 | 49.5 | 49.5 |
| B: glass fibers | 30 | 30 | 30 | 30 | 30 | 30 | 30 |
| HP3610 | | | | | | | |
| C: FM 1 | 20 | — | — | — | — | — | — |
| C + D: FM 2 | — | 20 | — | — | — | — | 20 |
| C + D + F: FM 3 | — | — | 20 | — | — | — | — |
| C + D + F: FM 4 | — | — | — | 20 | — | — | — |
| C + D + F: FM 5 | — | — | — | — | 20 | — | — |
| C + D + F: FM 6 | — | — | — | — | — | 20 | — |
| E: FM 7 | 0.5 | 0.5 | 0.5 | 0.5 | 0.5 | 0.5 | — |
| HDT-A [ ° C.] | 220 | 221 | 215 | 220 | 222 | 230 | 220 |
| UL 94 0.4 mm/ | V-0/45 | V-1/63 | V-1/72 | V-0/49 | V-1/87 | V-1/92 | V1/99 |
| time [sec.] | | | | | | | |
| GWFI [° C.] | 960 | 960 | 960 | 960 | 960 | 960 | 960 |
| CTI [volts] | 600 | 600 | 600 | 600 | 550 | 600 | 500 |
| MVR [cm³/10 min.] | 14 | 13 | 15 | 14 | 13 | 17 | 23 |
| Exudation | 2 | 2 | 1 | 1 | 1 | 1 | 1 |

With a polyamide having a melting point below 290° C. (PA 6,6:260° C.), it is not possible to achieve a polyamide composition having an HDTA of at least 280° C. Moreover, UL 94 V-0 is not attained here.

1. A flame-retardant polyamide composition having a heat deflection temperature HDT-A of at least 280° C., comprising
polyamide having a melting point of not less than 290° C. as component A;
fillers and/or reinforcers as component B;
phosphinic salt of the formula (I) as component C 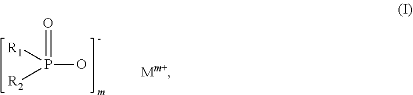
in which R₁ and R₂ are ethyl,
M is Al, Fe, TiOₚ or Zn,
m is 2 to 3, and
p=(4−m)/2;
compound selected from the group of the Al, Fe, TiOₚ and Zn salts of ethylbutylphosphinic acid, of dibutylphosphinic acid, of ethylhexylphosphinic acid, of butylhexylphosphinic acid and/or of dihexylphosphinic acid as component D; and
monoethylphosphinic salt of the formula II as component E 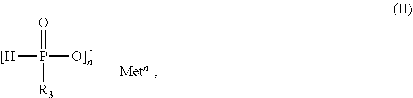
in which R₃ is ethyl,
Met is Al, Fe, TiO_{q} or Zn,
n is 2 to 3, and
q=(4−n)/2.

2. The flame-retardant polyamide composition as claimed in claim 1, wherein M and Met are Al, m and n are 3, and component D is an aluminum salt.

3. The flame-retardant polyamide composition as claimed in claim 1, wherein
the proportion of component A is 25% to 95% by weight,
the proportion of component B is 1% to 45% by weight,
the proportion of component C is 0.75% to 30% by weight,
the proportion of component D is 0.01% to 3% by weight, and
the proportion of component E is 0.01% to 2% by weight,
where the percentages are based on the total amount of the polyamide composition.

4. The flame-retardant polyamide composition as claimed in claim 3, wherein
the proportion of component A is 25% to 75% by weight,
the proportion of component B is 20% to 40% by weight,
the proportion of component C is 5% to 20% by weight,
the proportion of component D is 0.05% to 1.5% by weight, and
the proportion of component E is 0.01% to 0.5% by weight,
where the percentages are based on the total amount of the polyamide composition.

5. The flame-retardant polyamide composition as claimed in claim 1, which comprises, as a further component F, a phosphonic salt of the formula (IX) 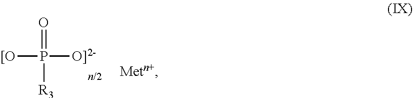
in which R₃ is ethyl,
Met is Al, Fe, TiO_{q} or Zn,
n is 2 to <4, and
q=(4−n)/2,
where component F is present in an amount of 0.005% to 1% by weight, especially in an amount of 0.01% to 0.5% by weight, based on the total amount of the polyamide composition.

6. The flame-retardant polyamide composition as claimed in claim 1, which comprises, as a further component G, an inorganic phosphonate.

7. The flame-retardant polyamide composition as claimed in claim 6, wherein the inorganic phosphonate is a compound of the formula (III) 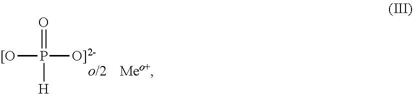
in which Me is Fe, TiOᵣ, Zn or especially Al,
o is 2 to 3, and
r=(4−o)/2,
where the compound of the formula (III) is present in an amount of 0.005% to 10% by weight, especially in an amount of 0.02% to 5% by weight, based on the total amount of the polyamide composition.

8. The flame-retardant polyamide composition as claimed in claim 1, which has a comparative tracking index measured by International Electrotechnical Commission Standard IEC-60112/3 of not less than 500 volts.

9. The flame-retardant polyamide composition as claimed in claim 1, which attains a V-0 assessment according to UL94 from thickness 3.2 mm to 0.4 mm.

10. The flame-retardant polyamide composition as claimed in claim 1, which has an HDT-A according to DIN EN ISO 75-3 of at least 300° C.

11. The flame-retardant polyamide composition as claimed in claim 1, wherein component A is an aromatic or semiaromatic polyamide or a mixture of two or more aromatic or semiaromatic polyamides or a mixture of nylon-6,6 and one or more aromatic or semiaromatic polyamides.

12. The flame-retardant polyamide composition as claimed in claim 11, wherein component A is an aromatic or semiaromatic polyamide or a mixture of two or more aromatic or semiaromatic polyamides.

13. The flame-retardant polyamide composition as claimed in claim 1, wherein glass fibers are used as component B.

14. The flame-retardant polyamide composition as claimed in claim 1, wherein components C, D and E are in particulate form, where the median particle size d₅₀ of these components is 1 to 100 μm.

15. The flame-retardant polyamide composition as claimed in claim 1, which comprises further additives as component H, where the further additives are selected from the group consisting of antioxidants, UV stabilizers, gamma ray stabilizers, hydrolysis stabilizers, costabilizers for antioxidants, antistats, emulsifiers, nucleating agents, plasticizers, processing auxiliaries, impact modifiers, dyes, pigments and/or further flame retardants other than components C, D, E, F and G.

16. The use of the polyamide composition as claimed in claim 1 for production of fibers, films and shaped bodies, especially for applications in the electricals and electronics sector.
